(19) United States
(12) Patent Application Publication
(10) Pub. No.: US 2018/0136006 A1
(43) Pub. Date: May 17, 2018

(54) A METHOD AND APPARATUS FOR PROVIDING NAVIGATION GUIDANCE

(71) Applicant: One of Seven LTD, Road Town (VG)

(72) Inventor: Theo STEER, London (GB)

(73) Assignee: One of Seven LTD, Road Town (VG)

(21) Appl. No.: 15/573,354

(22) PCT Filed: May 13, 2016
(86) PCT No.: PCT/GB2016/051384

§ 371 Date: Nov. 10, 2017

(30) Foreign Application Priority Data
May 14, 2015 (GB) 1508239.9

(51) Int. Cl. G01C 21/36

(52) U.S. Cl. CPC G01C 21/3691

(57) ABSTRACT

The disclosure relates to a method for providing navigation guidance comprising: defining a geographical-area for a particular user; populating a database with information relating to a plurality of remote-data-sources, wherein the information comprises time-stamped-location-data for each of the plurality of remote-data-sources; searching the database to identify one or more candidate-remote-data-sources based on matching candidate-time-stamped-location-data with: the particular user's geographical-area; and a predetermined discrete time interval; sending a report-request to the one or more candidate-remote-data-sources; receiving report-data from the one or more candidate-remote-data-sources in response to the report-request, the report-data for use in providing subsequent navigation guidance for the particular user.

The present disclosure relates to methods and apparatus for providing navigation guidance for a particular user. There is a need to provide improved navigation guidance based on prevailing conditions at locations that are relevant to the particular user.

According to a first aspect of the present disclosure there is provided a method for providing navigation guidance comprising: defining a geographical-area for a particular user; populating a database with information relating to a plurality of remote-data-sources, wherein the information comprises time-stamped-location-data for each of the plurality of remote-data-sources; searching the database to identify one or more candidate-remote-data-sources based on matching candidate-time-stamped-location-data with: the particular user's geographical-area; and a predetermined discrete time interval; sending a report-request to the one or more candidate-remote-data-sources; receiving report-data from the one or more candidate-remote-data-sources in response to the report-request, the report-data for use in providing subsequent navigation guidance for the particular user.

The method may advantageously provide information relevant to prevailing conditions at the geographical-area. Such information may possess advantageous accuracy and/or integrity having been derived from remote-data-sources determined to be present at the geographical-area, and/or to have been present at the geographical-area within a relevant predetermined discrete time interval. In particular, such information may advantageously provide a superior representation of prevailing conditions at the geographical-area compared to historical data relating to the geographical-area which may be out of date, or compared to data derived from a remote-data-source not located at the geographical-area which may therefore be spurious or inaccurate. Provision of such information may advantageously improve decision making regarding the choice of geographical-area, to which, or via which, a user may decide to navigate.

In one or more embodiments the geographical-area may comprise the particular user's location.

In one or more embodiments the geographical-area may comprise a predetermined area surrounding the particular user's location.

In one or more embodiments the geographical-area may comprise a plurality of venues within a boundary and identifying the one or more candidate-remote-data-sources may be further based on matching the candidate-time-stamped-location-data with a location of a venue and a predetermined property of the venue.

In one or more embodiments the geographical-area may further comprise a proximity of one or more of the plurality of venues based on a number of remote-data-sources located within a respective venue.

In one or more embodiments identifying the one or more candidate-remote-data-sources may be further based on matching the candidate-time-stamped-location-data with a predetermined time interval associated with the respective venue.

In one or more embodiments the predetermined time interval associated with the venue may be based on a number of remote-data-sources located within the venue.

In one or more embodiments the predetermined time interval associated with the venue may be based on a rate of change of a number of remote-data-sources located within the venue.

In one or more embodiments the time-stamped-location-data may be generated by an electronic device having at least one sensor.

In one or more embodiments the sensor may comprise one or more of: a microphone; an accelerometer; a chemical sensor; an orientation sensor; an optical sensor; a camera, a touch screen sensor; and a thermal sensor.

In one or more embodiments the method may further comprise: defining a preference-set for the particular user; and searching the database to identify one or more candidate-remote-data-sources based on further matching candidate-time-stamped-location-data with the particular user's preference-set; wherein the report request relates to the particular user's preference-set.

In one or more embodiments the method may further comprise: receiving a plurality of report-data from each of a plurality of candidate-remote-data-sources; generating aggregate-report-data from the received plurality of report-data, the aggregate-report-data for use in providing subsequent navigation guidance for the particular user.

In one or more embodiments the method may further comprise providing subsequent navigation guidance for the particular user.

In one or more embodiments the method may further comprise providing live news reports and/or information feeds relevant to the particular user's geographical area based on the received report-data.

According to a further aspect of the present disclosure there is provided an apparatus comprising: at least one processor; and at least one memory including computer program code, the at least one memory and the computer program code configured to, with the at least one processor, cause the apparatus to perform at least the following: define a geographical-area for a particular user; search a database to identify one or more candidate-remote-data-sources based on matching candidate-time-stamped-location-data with: the particular user's geographical-area; and a predetermined discrete time interval; send a report-request to the one or more candidate-remote-data-sources; and receive report-data from the one or more candidate-remote-data-sources in response to the report request, the report-data for use in providing subsequent navigation guidance for the particular user, wherein the database is populated with information relating to a plurality of remote-data-sources, the information comprising time-stamped-location-data for each of the plurality of remote-data-sources.

According to a further aspect of the present disclosure there is provided an apparatus comprising: at least one processor; and at least one memory including computer program code, the at least one memory and the computer program code configured to, with the at least one processor, cause the apparatus to perform at least the following: provide information to a remote server to define a geographical-area for a particular user; provide information to the remote server to cause the server to search a database to identify one or more candidate-remote-data-sources based on matching candidate-time-stamped-location-data with: the particular user's geographical-area; and a predetermined discrete time interval; and send a report-request to the one or more candidate-remote-data-sources; and receive report-data from the one or more candidate-remote-data-sources in response to the report request, the report-data for use in providing, via the apparatus, subsequent navigation guidance for the particular user, wherein the database is populated with information relating to a plurality of remote-data-sources, the information comprising time-stamped-location-data for each of the plurality of remote-data-sources.

According to a further aspect of the present disclosure there is provided a system comprising: an apparatus comprising: at least one processor; and at least one memory including computer program code, the at least one memory and the computer program code configured to, with the at least one processor, cause the apparatus to perform at least the following: define a geographical-area for a particular user; search a database to identify one or more candidate-remote-data-sources based on matching candidate-time-stamped-location-data with: the particular user's geographical-area; and a predetermined discrete time interval; send a report-request to the one or more candidate-remote-data-sources; and receive report-data from the one or more candidate-remote-data-sources in response to the report request, the report-data for use in providing subsequent navigation guidance for the particular user, wherein the database is populated with information relating to a plurality of remote-data-sources, the information comprising time-stamped-location-data for each of the plurality of remote-data-sources; the database; and a plurality of remote-data-sources configured to provide report-data in response to the report-request.

According to a further aspect of the present disclosure there is provided a computer readable medium comprising computer program code stored thereon, the computer readable medium and computer program code being configured to, when run on at least one processor, perform at least the following: define a geographical-area for a particular user; search a database to identify one or more candidate-remote-data-sources based on matching candidate-time-stamped-location-data with: the particular user's geographical-area; and a predetermined discrete time interval; send a report-request to the one or more candidate-remote-data-sources; and receive report-data from the one or more candidate-remote-data-sources in response to the report-request, the report-data for use in providing subsequent navigation guidance for the particular user; wherein the database is populated with information relating to a plurality of remote-data-sources, the information comprising time-stamped-location-data for each of the plurality of remote-data-sources.

One or more embodiments will now be described by way of example only with reference to the accompanying drawings in which:

FIG. 1 shows an example embodiment of a flow chart for a method for providing navigation guidance based on time-stamped-location-data;

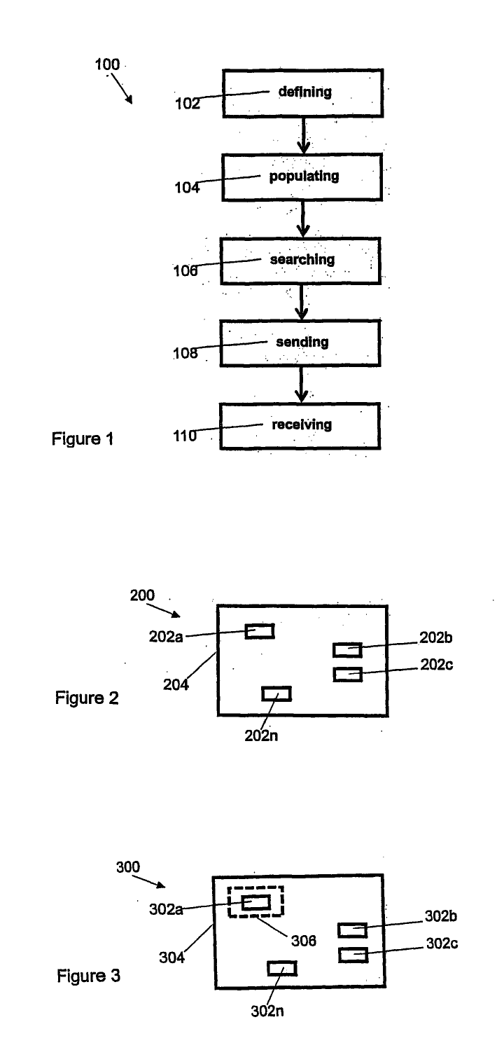

FIG. 2 shows an example embodiment of a method for defining a geographical area comprising a plurality of venues;

FIG. 3 shows an example embodiment of a method for defining a geographical area comprising a proximity of a venue;

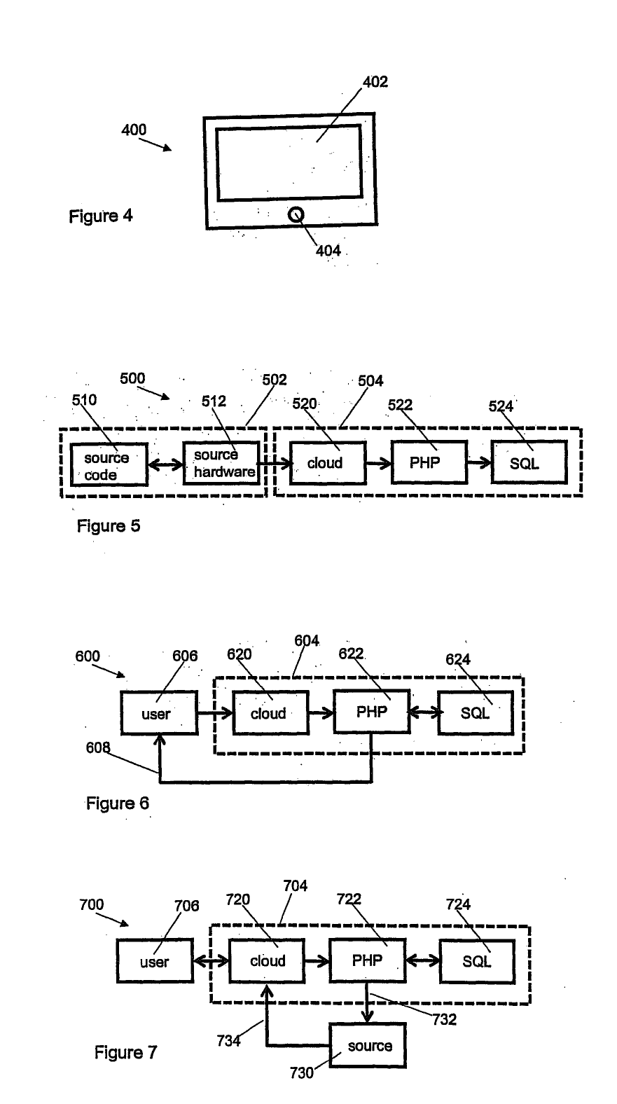

FIG. 4 shows an example embodiment of an apparatus with at least one sensor;

FIG. 5 shows an example embodiment of a system for populating a database;

FIG. 6 shows an example embodiment of a system for providing report-data to a user;

FIG. 7 shows an example embodiment of a system for populating a database and providing report-data to a user;

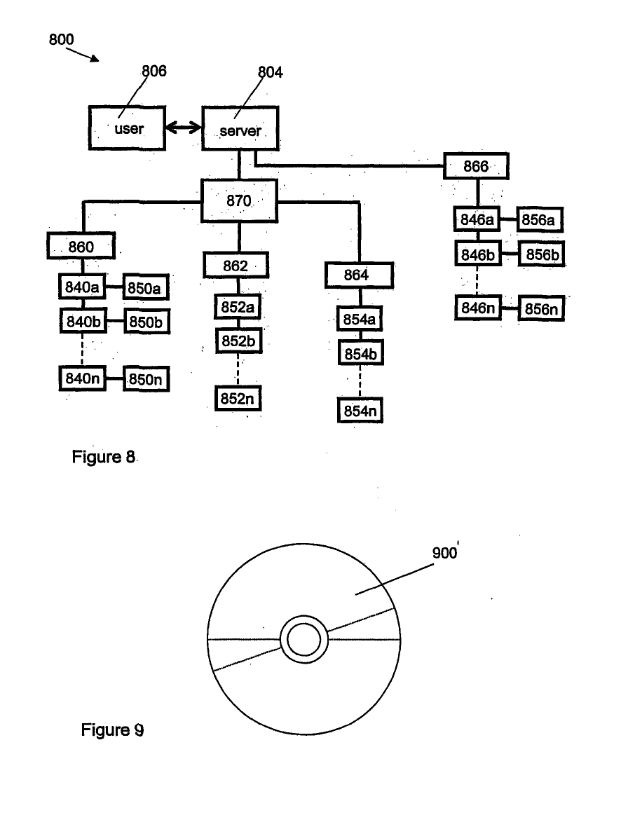

FIG. 8 shows an example embodiment of a system for providing report-data from a plurality of remote-data-sources to a user; and

FIG. 9 shows an example embodiment of a computer readable medium.

While the disclosure is amenable to various modifications and alternative forms, specifics thereof have been shown by way of example in the drawings and will be described in detail. It should be understood, however, that other embodiments, beyond the particular embodiments described, are possible as well.

The instructions and/or flowchart steps in the above Figures can be executed in any order, unless a specific order is explicitly stated. Also, those skilled in the art will recognize that while one example set of instructions/method has been discussed, the material in this specification can be combined in a variety of ways to yield other examples as well, and are to be understood within a context provided by this detailed description.

In some example embodiments the set of instructions/method steps described above are implemented as functional and software instructions embodied as a set of executable instructions which are effected on a computer or machine which is programmed with and controlled by said executable instructions. Such instructions are loaded for execution on a processor (such as one or more CPUs). The term processor includes microprocessors, microcontrollers, processor modules or subsystems (including one or more microprocessors or microcontrollers), or other control or computing devices. A processor can refer to a single component or to plural components.

In other examples, the set of instructions/methods illustrated herein and data and instructions associated therewith are stored in respective storage devices, which are implemented as one or more non-transient machine or computer-readable or computer-usable storage media or mediums. Such computer-readable or computer usable storage medium or media is (are) considered to be part of an article (or article of manufacture). An article or article of manufacture can refer to any manufactured single component or multiple components. The non-transient machine or computer usable media or mediums as defined herein excludes signals, but such media or mediums may be capable of receiving and processing information from signals and/or other transient mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

In some examples, one or more instructions or steps discussed herein are automated. The terms automated or automatically (and like variations thereof) mean controlled operation of an apparatus, system, and/or process using computers and/or mechanical/electrical devices without the necessity of human intervention, observation, effort and/or decision.

Electronic devices may be used to provide navigation guidance to users' thereof, such as by satellite navigation systems like the Global Positioning System (GPS), Glonass, Galileo, or other systems or modalities of geographical location systems including by assessment of proximity to any fixed or mobile transmitting or receiving device, equipment or aerial for example Wi-Fi or Bluetooth systems, triangulation, dead reckoning, and other geopositioning systems. In some examples a user may desire to travel to a specific destination but may face a plurality of possible routes by which to travel to the specific destination. In other examples, a user may have a plurality of different destinations to which they could travel. Users may make choices about preferred routes or destinations based on historical data relating to different destinations, including both their ultimate destination for a particular occasion and intermediate destinations between their instant location and their ultimate destination. In the following disclosure, terms such as destination, location, or venue, will be understood to refer to both ultimate destinations and intermediate destinations.

The prevailing conditions at a particular destination may not be accurately represented by historic data relating to the particular destination. An advantageous method may therefore provide navigation guidance based on information obtained in real time, or during a predetermined time interval including the recent past, from sources of information based at, or proximal to, a particular destination.

FIG. 1 shows flow chart 100 depicting a method for providing navigation guidance. The method comprises a first step 102 of defining a geographical area for a particular user. Many different techniques may be employed to define the geographical area. The geographical area may define a real world geographic area which may include a plurality of possible destinations for selection by the user. A user may input details of the geographical area into an electronic device by using a user interface. In some examples, the geographical area may comprise the particular user's location. In some examples, the geographical area may comprise a location to which the particular user may intend to travel, or may be selected for any purpose by the user, and may be defined by numerous potential parameters or characteristics such as street or area name, post or area code, etc., or may be recommended based on an Administrator's criteria, for example random search for a particular type of venue over a broadly defined area. In some examples the geographical area may comprise a predetermined area surrounding the particular user's location, or may relate to the location of a different user or person, or may be selected at random. An electronic device may determine the geographical area automatically based on the location of the electronic device, as determined by a GPS system or other geographical locating device built into the device, for example. In some examples automatic determination may comprise determining a boundary extending around the location of the electronic device based on a predetermined distance between the location and the boundary or based on a predetermined proximity that comprises the location. For example, a predetermined proximity may comprise a particular district of a town or city that a user, and their electronic device, is located in.

In some examples the step of defining a geographical area for a particular user may depend on the particular user's location relative to a particular predetermined boundary. For example, if the particular user is located within a first predetermined boundary then the geographical area may comprise locations within the first predetermined boundary and optionally locations within a particular proximity of the first predetermined boundary. If the particular user moves outside of the first predetermined boundary and into a region enclosed by a second predetermined boundary, then the geographical area may be redefined to comprise locations within the second predetermined boundary and optionally locations within a given proximity of the second predetermined boundary. Thereby, the particular user may be provided with information relevant to venues that are relevant to the particular user based on the particular user's real time location. Where the particular user crosses a particular boundary the geographical area may change to exclude venues that are considered to be too far away from the particular user to be of interest and to include venues that are considered to have become close enough to the particular user to have become of interest. By changing the definition of the geographical area only occasionally, when the particular user crosses a boundary, the user may be presented with an updated selection of venues only on a correspondingly occasional basis. Thereby, the process of updating the selection of venues may be provided more efficiently, requiring lower system resources such as communications bandwidth or server processor power, than a process that updates the selection of venues on a continuous basis.

The method comprises a second step 104 of populating a database with information relating to a plurality of remote-data-sources. A remote-data-source may be an electronic device, which may be fixed in a particular location or may be mobile and may be associated with a particular user. The information comprises time-stamped-location-data for each of the plurality of remote-data-sources and may optionally further comprise static information as to the nature of facilities at the location. Time-stamped-location-data comprises information representative of the time that the time-stamped-location-data is generated and information representative of the location at which the time-stamped-location-data is generated. In some examples, time-stamped-location-data may optionally comprise information representative of prevailing conditions at the location at which the time-stamped-location-data was generated. Thus, the database may comprise a record of the geographical location of the plurality of remote-data-sources. In some embodiments, the database contains only the geographical locations and an associated identifier unique to the remote-data-source and may contain also static information as to the nature of the facilities at the location but does not contain information representative of prevailing conditions at the location at which the time-stamped-location-data was generated or only a subset of the information representative of prevailing conditions available from and/or stored at the remote-data-source. Data gathering for the database may be performed in a variety of different modalities for example automatic updating of the database generated by time lapse and/or movement of each remote-data-source and manual updating according to individual user input, and modalities adopted by an administrator to enhance database maximisation, for example drone, live satellite, closed circuit sound and/or visual recording devices, fixed source, mobile source, statistical source, establishment source and other modalities of feed information sources.

The method comprises a third step 106 of searching the database to identify one or more candidate-remote-data-sources. A candidate-remote-data-source is an example of a remote-data-source that is selected during the third step 106 based on matching candidate-time-stamped-location-data with the particular user's actual or selected geographical area; and a predetermined discrete time interval. Candidate-time-stamped-location-data is an example of time-stamped-location-data provided by a candidate-remote-data-source. Matching based on the particular user's geographical area includes determining that the candidate-time-stamped-location-data was generated within the geographical area or within a certain distance or proximity of the geographical area. Matching based on the predetermined-discrete-time-interval includes determining that the candidate-time-stamped-location-data was generated during the predetermined-discrete-time-interval. Additionally users may submit reports voluntarily to the database which may for example be displayed automatically for other users searching the relevant location or otherwise transmitted or disseminated.

In some examples, the predetermined-discrete-time-interval may be a predetermined period of time in the past from the current time.

The method comprises a fourth step 108 of sending a report-request to the one or more candidate-remote-data-sources. The report-request may comprise information representative of a desire to receive a report, or a particular type of report, from the candidate-remote-data-sources. The candidate-remote-data-source may subsequently provide an automated response to the request or may provide an alert signal to a user of the candidate-remote-data-source to indicate to the user that they may provide a report.

The method comprises a fifth step 110 of receiving report-data from the one or more candidate-remote-data-sources in response to the report-request. A particular candidate-remote-data-source may or may not provide report-data. In those examples where a candidate-remote-data-source provides report-data, the report-data may be representative of prevailing conditions at the location or in the geographical area of the candidate-remote-data-source during the predetermined-discrete-time-interval. The report-data may be suitable for use in providing subsequent navigation guidance for the particular user. That is, the report-data may enable the particular user to determine an advantageous destination to travel to or via. In other examples, the report-data may enable the particular user to determine one or more destinations to avoid travelling to or via.

FIG. 2 shows an example of a method 200 for determining a geographical area for a particular user. The geographical area comprises a plurality of venues 202(a-n) within a boundary 204. The boundary 204 may be determined based on a location of a user or electronic device. The boundary 204 may comprise the location of the user or the electronic device or the boundary 204 may comprise a location selected by the user. The boundary 204 may comprise a predetermined proximity, such as a district of a town or city, or the boundary 204 may be defined based on a predetermined distance from a given point. It will be appreciated that, while the boundary 204 shown in FIG. 2 is rectangular, a boundary may have any particular shape. It will be appreciated that while the geographical area of FIG. 2 comprises a plurality of venues 202(a-n), in other examples a geographical area could comprise a single venue located within a particular boundary.

A first venue 202a may comprise a first part of the geographical area. Similarly, the remaining plurality of venues 202(b-n) may comprise the remainder of the geographical area. It will be appreciated that, while the plurality of venues 202(a-n) comprise a subset of the area enclosed by the boundary 204, in other examples a plurality of venues may consist of the entire area contained by a boundary. Since the remaining plurality of venues 202(b-n) are each similar to the first venue 202a, they will not be discussed further here. The first venue 202a may comprise a predetermined portion of space. In some examples the first venue 202a may comprise a building or buildings, such as a bar, restaurant, nightclub, attraction, sports venue such as a bowling alley, or any other building to which a user may travel. In other examples the first venue 202a may comprise an outdoor location, such as a beech, park, plaza, sports venue such as a golf course, or other outdoor location to which a user may travel. In some examples the first venue 202a may comprise a building or buildings and a proximity surrounding the building or buildings. Similarly, in some examples the first venue 202a may comprise an outdoor location and a proximity surrounding the outdoor location. In some examples the first venue 202a may comprise a temporary location. It will be appreciated that, while the first venue 202a shown in FIG. 2 is rectangular, a venue may have any particular shape.

Having defined a geographical area comprising a plurality of venues, the method step of identifying one or more candidate-remote-data-sources may be further based on matching the candidate-time-stamped-location-data with a location of a venue and optionally a predetermined property of the venue. By matching candidate-time-stamped-location-data with a location of a venue it may be possible to improve the quality and integrity of report-data provided to the particular user, by ensuring that the report-data is generated by any number of remote-data-sources present at the venue concerned or proximal to the venue concerned. This may advantageously avoid spurious report-data reaching the particular user because remote-data-sources that cannot necessarily provide accurate information relating to prevailing conditions at the venue, since they are not present at the venue or have not been present at the venue in the recent past, are avoided. This also reduces network congestion as only the candidate-remote-data-sources are queried rather than all remote-data-sources. Further, the remote-data-sources may collect data regarding the prevailing conditions and store this information locally. If the information is not requested it may be deleted or archived. Thus, a central server does not need to store all of the information obtained by the remote-data-sources, instead the information may be stored locally and only transmitted to the central server if required.

By matching candidate-time-stamped-location-data with a predetermined property of a venue it is possible to exclude venues that are not of a relevant type with respect to a particular user. In other examples, the exclusion of irrelevant venues may be performed at the earlier step of defining the geographical area, by including only venues that are of a relevant predetermined type.

FIG. 3 shows an example of a method 300 for determining a geographical area for a particular user. Features of FIG. 3 that are similar to features of FIG. 2 have been given similar reference numerals and may not necessarily be discussed further here. The method 300 includes defining a boundary 304 and then defining a geographical area that comprises a plurality of venues 302(a-n). In other examples the boundary may comprise only a single venue. The method 300 comprises further defining the geographical area to comprise a proximity of one or more of the plurality of venues 302(a-n) based on a number of remote-data-sources located within a respective venue. In this example, a proximity 306 of a first venue 302a is part of the geographical area and the extent of the proximity 306, or the particular area outside of the first venue 302a that comprises the proximity 306, is based on a number of remote-data-sources located within the first venue 302a. In some examples the proximity may be based on a number of candidate-remote-data-sources identified within the first venue 302a. If the number of remote-data-sources present at the first venue 302a is less than a predetermined number, then the extent of the proximity 306 may be increased in order to enable the identification of candidate-remote-data-sources that may be able to provide accurate information about prevailing conditions within the first venue 302a by virtue of their proximity to it. Alternatively, if the number of remote-data-sources located within the first venue 302a is greater than a predetermined number then the proximity 306 may be reduced in extent, or even reduced to zero, as a sufficient number of remote-data-sources may be located inside the first venue 302a to provide accurate information about prevailing conditions therein. In some examples of the method 300, a plurality of numbers of remote-data-sources may be predetermined and used to define a plurality of different proximities to include within the geographical area, based on the particular number of remote-data-sources present in a particular venue at a particular time, or within a particular time interval.

In some examples, the method step of identifying the one or more candidate-remote-data-sources may be further based on matching the candidate-time-stamped-location-data with a predetermined time interval associated with a venue. Matching may comprise identifying candidate-time-stamped-location-data that was generated within the predetermined time interval associated with the venue. Since prevailing conditions at a particular venue are subject to change over time, it may be possible to identify a ‘half-life’ for information relating to a particular venue. Here, half-life may refer to a time interval during which a particular proportion (such as one half) of a set of pieces of information about prevailing conditions at a venue become obsolete, or no longer relevant. In order to provide accurate, up-to-date, information about a venue to a particular user, it is advantageous to exclude information from remote-data-sources that were present at a venue longer ago than a predetermined time interval, such as a half-life period. Determination of an appropriate predetermined time interval for a particular venue may be achieved by analysis of a time series of historical report-data relating to that particular venue, for example.

In some examples, the predetermined time interval associated with a venue may be based on a number of remote-data-sources located within the venue. Where greater than a predetermined number of remote-data-sources are located within the venue the pre-determined time interval may be short, or even zero, as an adequate number of remote-data-sources may be present at the venue, or have only recently departed from the venue, to provide an accurate representation of prevailing conditions at the venue. Alternatively, if fewer than a predetermined number of remote-data-sources are present at a venue then it may be advantageous to provide for a longer predetermined time interval to enable acquisition of report-data from a larger number of candidate-remote-data-sources than may be present at the venue at an instant time.

In some examples the predetermined time interval associated with the venue may be based on a rate of change of a number of remote-data-sources located within the venue. Where a high rate of change of remote-data-sources occurs within a particular venue the prevailing conditions at that venue may change more rapidly and therefore the predetermined time interval may advantageously be reduced. The predetermined time interval may be determined by the user.

FIG. 4 shows an apparatus 400 configured to perform methods according to the present disclosure. The apparatus 400 is an electronic device, with a display screen 402, and a sensor 404. The time-stamped-location-data may be generated by the electronic device.

Where the electronic device comprises at least one sensor, the time-stamped-location-data may further comprise sensor data. It will be appreciated that an electronic device may comprise many different types of sensor, such as one or more of a microphone, an accelerometer, a chemical sensor, an orientation sensor, a touchscreen sensor, a plurality of buttons or a keyboard, a camera or other visual or optical sensor, and a thermal sensor.

The apparatus 400 may be an example of a remote-data-source. Where the apparatus 400 is identified as a candidate-remote-data-source, it may receive a report-request and may provide report-data in response to the report-request. The report-data may be representative of signalling generated by one or more sensors associated with the apparatus 400.

In some examples, the report-data may be generated automatically. For example, a microphone may record sound levels at a venue. The recorded sound levels may be provided as report-data. The recorded sound levels may be analysed to determine a sound level relating to a volume of human speech. Where the venue is a restaurant, for example, a detected volume of human speech may provide a good indication of the number of people present at the venue and their disposition. In some examples, the sound recorded by a microphone may be stored in memory for a predetermined time. If the remote-data-source receives a report-request within the predetermined time it may be automatically configured to provide report-data relevant to a venue even after the remote-data-source has left the venue. This method provides an additional technical advantage that report-data, such as recorded sound data, does not need to be constantly, or even periodically, uploaded from a remote-data-source to a database; it can be provided only when requested, thereby reducing bandwidth requirements of communications channels between the remote-data-sources, the database and a particular user's electronic device. Furthermore, this method may provide the technical advantage of reducing the memory required for the database; by storing data locally on a remote-data-source that may have a certain memory capacity of its own, and by only providing report-data on request, the memory capacity of the database may be reduced without compromising performance.

In some examples, the sensor may comprise an accelerometer. Accelerometer data may provide an accurate representation of the behaviour of a user of a remote-data-source. Where the remote-data-source is a smartphone for example, accelerometer data may indicate whether, and at what intensity, users present in a venue like a nightclub are dancing.

In some examples, the sensor may comprise an optical sensor, such as a camera built into a smartphone or smartwatch. Optical sensor data may provide an accurate representation of the behaviour of persons present in a particular venue. For example, optical sensor data may indicate whether, and at what intensity, users present in a venue like a nightclub are dancing.

In some examples, the sensor may comprise a chemical sensor which may be configured to sense concentrations of chemical species in the atmosphere. For example, a sensor may record data representative of carbon dioxide levels, which may be representative of the number, or density, of people present at a particular venue, and/or their overall levels of physical exertion. Alternatively, the sensor may record levels of pollutants such as cigarette smoke or motor vehicle fumes.

An orientation sensor may be used to provide data representative of whether a user of a remote-data-source, such as a smartphone, is sitting or standing. Such data may provide insight into prevailing conditions at a venue such as a bar, where a greater number of users standing may be representative of the presence of a greater number or density of people at the venue.

A user interface, such as a touchscreen display sensor, may be configured to provide report-data based on user input. Other examples of user interfaces may be used in conjunction with the present disclosure, such as a keyboard or plurality of buttons, or any other user data input interface that may be configured by a user to provide report-data. Such report-data may relate to objective or subjective aspects of prevailing conditions at a venue. For example, where queueing is in operation at a venue, a user may measure or estimate the time required to complete a queueing operation. Where a venue is a restaurant or bar, such information may be representative of how rapid or slow service may be at the particular establishment. In some examples, the user may provide touchscreen sensor data representative of their subjective opinion of a venue, such as their opinion of the atmosphere or ambience prevailing at the venue. Such sensor data may be stored for a predetermined time, or may be provided by a user on receiving a report-request within a predetermined time of time-stamped-location-data having been generated by a remote-data-source associated with the user. In this way, a particular user can be provided with accurate, time sensitive, information relating to a venue while reducing the requirement for communications channel bandwidth.

In some examples, methods of the present disclosure may further comprise defining a preference-set for the particular user. A preference-set may comprise information representative of characteristics of venues that are of interest to the particular user. Such characteristics may relate to the type of venue, such as whether it is a bar or a restaurant, or may relate to the prevailing conditions at a venue, such as whether it is busy or quiet, or may relate to both the type of venue and the prevailing conditions therein, such as whether it is a busy bar or a quiet restaurant. Such characteristics may also relate to permanent or temporary features of particular establishments, for example a bar or restaurant of particular ethnicity or staging a particular themed event. Such characteristics may also be identified by purpose, examples being “Eat”, and/or “Drink”, and/or “Dance”.

The step of searching a database to identify one or more candidate-remote-data-sources may be based on further matching candidate-time-stamped-location-data with the particular user's preference-set. Since the candidate-time-stamped-location-data may comprise information about the geographical area or venue that a candidate-remote-data-source is, or was recently, present at it may be unnecessary to predetermine characteristics or properties of a venue. The user of a remote-data-source may provide information relevant to their situation, such as that they are present in a venue that is a bar or a restaurant, or that the venue is busy or quiet. This may obviate the need to maintain a database configured to record venue types. Alternatively, this may improve the accuracy of a database of venue types because when a new venue opens candidate-time-stamped-location-data may be used to assign a property or characteristic to the venue concerned automatically.

In some examples the methods of the present disclosure may further comprise defining a preference-set for the particular user enabling identification by class or category of other remote-data-sources populating an identified location or geographical area.

Having searched the database to identify one or more candidate-remote-data-sources the report-request may relate to, or be based on, the particular user's preference-set. In this way, only remote-data-sources that may have information pertinent to the particular user may be sent report-requests, thereby reducing overall bandwidth usage of the communications channels required to convey the report-requests.

In some examples, methods of the present disclosure may further comprise receiving a plurality of report-data from each of a plurality of candidate-remote-data-sources and generating aggregate-report-data from the received plurality of report-data. The aggregate-report-data may be based on the report-data received from some or all of the candidate-remote-data-sources. In some examples, report-data may differ by greater than a predetermined extent from an average of all received report-data may be excluded from further consideration. Report-data chosen to form the aggregate-report-data may be combined by averaging, aggregation, or any by any other statistical technique known to persons skilled in the art. The aggregate-report-data may thereby provide more accurate information for use in providing subsequent navigation guidance for the particular user. For example, if a particular remote-data-source with a microphone is situated close to a particularly loudmouthed individual it may give the impression that a venue is busier than is actually the case. However, by aggregating a plurality of report-data received from a plurality of remote-data-sources distributed throughout the venue, information that is more accurately representative of prevailing conditions at the venue may be provided to the particular user.

In some examples, selection, prioritisation, preference, or exclusion of candidate-remote-data-sources may be based on individual candidate-remote-data-source characteristics examples being established user-data-input accuracy or approval statistics, or other identifying characteristics. Thereby, users or remote-data-sources that consistently provide report-data that is significantly different than the majority of users at a particular venue may be disregarded, while users that consistently provide report-data that is consistent with a majority of other users at a particular venue may be selected, or given greater weight in forming aggregate-report-data. In some examples users may be assigned a weighting for forming aggregate-report-data based on historical data, relating to the consistency of their report-data relative to that of other relevant users, over a particular period of time. This particular period of time may be significantly longer that the predetermined discrete time interval for matching candidate-time-stamped-location-data. Thereby, report-data generated in a plurality of different venues may be used to determine a user's reliability for the purpose of forming aggregate-report-data. In some examples, the speed by which report-data is received in response to previous report-requests may be used to determine whether a remote-data-source is selected as a candidate-remote-data-source, whereby only remote-data-sources that have established an ability to respond quickly to report-requests may be sent report-requests. This may advantageously reduce the use of communications network bandwidth by avoiding sending report-requests to remote-data-sources that are unlikely to respond sufficiently quickly to report-requests to be able to provide timely and/or accurate report-data relevant to prevailing conditions at a particular venue.

In some examples the methods of the present disclosure may further comprise a system enabling keyword based communication between a user and a candidate-remote-data-source to supplement information available to the user. In some examples such communication may include character limited messaging. In some examples such communication may include live picture transfer. In some examples such communication may include live sound transfer.

An apparatus according to the present disclosure may comprise: at least one processor; and at least one memory including computer program code, the at least one memory and the computer program code configured to, with the at least one processor, cause the apparatus to perform at least the following. Define a geographical-area for a particular user in accordance with any of the defining geographical-area methods disclose above. Search a database to identify one or more candidate-remote-data-sources based on matching candidate-time-stamped-location-data with: the particular user's geographical-area; and a predetermined discrete time interval, wherein the database may be populated with information relating to a plurality of remote-data-sources, the information comprising time-stamped-location-data for each of the plurality of remote-data-sources. It will be appreciated that the apparatus may not comprise the database; for example a smartphone may be said to search a database located on a remote server by providing instructions to the server representative of a search strategy that may then be executed by the server. Send a report-request to the one or more candidate-remote-data-sources; the report-request may be sent via the internet or any other communications network. Receive report-data from the one or more candidate-remote-data-sources in response to the report request, the report-data for use in providing subsequent navigation guidance for the particular user. The apparatus may then optionally enable keyword and/or character restricted and/or visual communication between users. The apparatus may then optionally provide navigation guidance to the particular user to enable them to navigate to the geographical area, or a location therein, based on the content of the report-data.

In some examples the apparatus may then optionally provide live news reports and/or information feeds, relevant to the particular user's geographical area, based on the received report-data. Thereby, the particular user may receive information relating to prevailing conditions at a particular venue on a real-time basis. Such information may enable improved decision making by the particular user as to which, if any, venue the particular user may decide to navigate to or via.

FIG. 5 shows an example system 500 according to the present disclosure. The system 500 comprises a remote-data-source 502 and a network server system 504. The remote-data-source 502 comprises a hardware system 510 configured to run computer program code 512. The remote-data-source 502 is configured to generate time-stamped-location-data.

The network server system 504 comprises a cloud computing platform 520 connected to a webserver 522 that is connected to a database 524. In some examples the webserver 522 may be configured to run PHP: Hypertext Preprocessor (PHP) or any other suitable programming language. In some examples the database 524 may be configured with Structured Query Language (SQL) or any other suitable programming language. In some examples the network server system 504, webserver 522 and database 524 may be so organised or configured as to operate in formats or languages or systems providing comparative functionalities yet to be developed.

The remote-data-source 502 is connected to the network server system 504 by any suitable communication channel. Thereby, the remote-data-source 502 may communicate time-stamped-location-data to the network server system 504. The time-stamped-location-data may be processed to flow through the network server system 504 to populate the database 524 with time-stamped-location-data relating to the remote-data-source 502. It will be appreciated that a plurality of remote-data-sources (not shown) may similarly communicate time-stamped-location-data to the network server system 504 to thereby populate the database 524 with time-stamped-location-data relating to each of the plurality of remote-data-sources.

FIG. 6 shows an example system 600 according to the present disclosure. Features of the system 600 that are similar to features of the system of FIG. 5 have been given similar reference numerals and will not necessarily be discussed further here. The system 600 comprises an electronic device 606 associated with a particular user. For example, the electronic device 606 may be the particular user's smartphone, smartwatch, or any comparable consumer device. The electronic device 606 is configured to define a geographical area, either automatically, or based on input provided by the particular user. The electronic device 606 may optionally be configured to define a preference-set for the particular user.

The electronic device 606 is connected by a communication channel to a cloud computing platform 620 within a network server system 604. Thereby, the electronic device 606 may communicate the particular user's geographical area and optional preference set to the network server system 604. A webserver 622 is configured to receive data representative of the geographical area and optionally the preference set from the cloud 620. The webserver 622 is thereby configured to communicate with a database 624 to obtain information from the database 624 relating to venues within the geographical area. The webserver 622 is then configured to provide information representative of the venues within the geographical area to the electronic device 606 via a suitable communications channel 608. The particular user may thereby obtain information relating to venues within the geographical area and that may additionally match their preference set.

FIG. 7 shows an example system 700 according to the present disclosure. Features of the system 700 that are similar to features of the systems of FIG. 5 or 6 have been given similar reference numerals and will not necessarily be discussed further here.

The system 700 comprises an electronic device 706 associated with a particular user and configured to define a geographical area and optionally a preference-set. The electronic device 700 is configured to communicate the geographical area and optionally the preference-set to a network server system 704. This communication may be considered to be a report-request because it may configure a webserver 722 to interrogate a database 724 populated with information relating to a plurality of remote-data-sources in order to identify one or more candidate-remote-data-sources. The webserver 722 may then communicate a report request 732 to a candidate-remote-data-source 730. It will be appreciated that the webserver 722 may communicate a plurality of report-requests to a plurality of candidate-remote-data-sources (not shown). The candidate-remote-data-source 730 may then be configured to communicate report-data 734 to a cloud computing platform 720 within the network server system 704. The cloud 720 may communicate the report-data to the electronic device 706, or in some example the cloud 720 may process the report-data before providing processed-report-data, such as aggregate-report-data, to the electronic device. In this way, the particular user may obtain information suitable for providing subsequent navigation guidance based on the prevailing conditions at one or more venues within the geographical area.

FIG. 8 shows an example system 800 according to the present disclosure. The system 800 comprises an electronic device 806 associated with a particular user and a network server system 804 that comprises a database. The system 800 further comprises a plurality of remote-data-sources 850(a-n), 852(a-n), 854(a-n), 856(a-n) configured to provide report-data in response to a report-request.

The electronic device 806 is configured to determine a geographical area, which in this example corresponds to one or more of a festival, market, shopping mall or other public space. The geographical area comprises a plurality of venues 860, 862, 864, 866. In this example, a first venue 860, a second venue 862 and a third venue 864 are grouped together into a venue group 870. The venue group 870 may comprise venues that are geographically or thematically linked. A fourth venue 866 is segregated within the database as it is not thematically or geographically linked to the venue group 870.

The first venue 860 comprises a plurality of events 840(a-n), which may take place according to a first schedule. A first event 840a may be matched to a first-remote-data-source 850a based on the first-remote-data-source being present at the first venue during a time interval corresponding to the time of the first event 840a based on the first schedule. Thereby, the first-remote-data-source may be identified as a candidate-remote-data-source for the first event and may thereby receive report-requests from a particular user interested in attending the first event in a subsequent repetition of the first schedule. For example, the first venue 860 may be a music venue within a festival and the first event 840a may comprise a performance by a first artist. By only sending report-requests to remote-data-sources physically present at the first event 840a the report-data provided to the particular user may have an improved level of accuracy and integrity compared to a less discriminating method for selecting candidate-remote-data-sources.

In this example the second venue 862 does not offer a schedule of events and is therefore associated with a plurality of remote-data-sources 852(a-n) as already disclosed above in relation to venues generally. Where a particular user provides a report-request for a particular venue, such as the second venue 862, within the venue group 870, the particular user may advantageously also be supplied with report-data from a third plurality of remote-data-sources 854(a-n) associated with the third venue 864. An advantage to the particular user may arise from the combination of the improved accuracy and integrity of the report-data provided in relation to the third venue 864 together with the potential that the third venue may be of interest to the particular user because of the thematic or geographical link between the third venue 864 and the second venue 862 about which the particular user originally made a report request. The system 800 may avoid an unnecessary increase in bandwidth usage of communications channels or avoid annoying the particular user, or wasting their time, by advantageously choosing not to provide report-data to the particular user about the fourth venue 866 because it is not thematically or geographically linked to the second venue 862 in which the particular user has expressed and interest. Thereby, report-data provided to the particular user may be improved in terms of its accuracy, integrity and relevance.

In some examples the system 800 may comprise encryption and/or password protection. Thereby, a user of any electronic device that is located outside of the geographical area, or outside of a boundary the area within which comprises the geographical area, may be prevented from accessing the network server system 804 and thereby be prevented from either gaining access to, or providing, report-data. This may further improve the security and integrity of the method of the present disclosure.

FIG. 9 shows an optical storage disk 900 which is an example of a computer readable medium comprising computer program code stored thereon. The computer readable medium and computer program code being configured to, when run on at least one processor, perform at least the following. Define a geographical-area for a particular user. Search a database to identify one or more candidate-remote-data-sources based on matching candidate-time-stamped-location-data or other stored data with: the particular user's geographical-area; and a predetermined discrete time interval, wherein the database is populated with information relating to a plurality of remote-data-sources, the information comprising time-stamped-location-data for each of the plurality of remote-data-sources. Send a report-request to the one or more candidate-remote-data-sources. Receive report-data from the one or more candidate-remote-data-sources in response to the report-request, the report-data for use in providing subsequent navigation guidance for the particular user;

Methods, systems and apparatus of the present disclosure may thereby provide a particular user with the capability to receive report-data that enables them to make a better informed decision for selecting a venue to navigate to, based on the prevailing conditions at one or more possible candidate venues. Having selected a venue or destination to navigate to, a particular user's electronic device may be configured to provide instructions to the user to enable them to navigate to the selected venue or destination. Such instructions may comprise providing details of the venue or destination, such as providing an address or a point on a map. Such instructions may comprise providing turn-by-turn instructions to enable the user to navigate to the venue or destination.

Methods, systems and apparatus of the present disclosure may provide a technically superior way of monitoring the prevailing conditions at venues, by using report-data generated by remote-data-sources that were, or are, present at the relevant venue at a relevant time.

It will be appreciated that any components said to be coupled may be coupled or connected either directly or indirectly. In the case of indirect coupling, additional components may be located between the two components that are said to be coupled.

In this specification, example embodiments have been presented in terms of a selected set of details. However, a person of ordinary skill in the art would understand that many other example embodiments may be practiced which include a different selected set of these details. It is intended that the following claims cover all possible example embodiments.

1. A method for providing navigation guidance comprising:
defining a geographical-area for a particular user;
populating a database with information relating to a plurality of remote-data-sources, wherein the information comprises time-stamped-location-data for each of the plurality of remote-data-sources;
searching the database to identify one or more candidate-remote-data-sources based on matching candidate-time-stamped-location-data with:
the particular user's geographical-area; and
a predetermined discrete time interval;
sending a report-request to the one or more candidate-remote-data-sources;
receiving report-data from the one or more candidate-remote-data-sources in response to the report-request, the report-data for use in providing subsequent navigation guidance for the particular user.

2. The method of claim 1, wherein the geographical-area comprises the particular user's location.

3. The method of claim 1, wherein the geographical-area comprises a predetermined area surrounding the particular user's location.

4. The method of claim 1, wherein the geographical-area comprises a plurality of venues within a boundary and identifying the one or more candidate-remote-data-sources is further based on matching the candidate-time-stamped-location-data with a location of a venue and a predetermined property of the venue.

5. The method of claim 4, wherein the geographical-area further comprises a proximity of one or more of the plurality of venues based on a number of remote-data-sources located within a respective venue.

6. The method of claim 4, wherein identifying the one or more candidate-remote-data-sources is further based on matching the candidate-time-stamped-location-data with a predetermined time interval associated with the respective venue.

7. The method of claim 6, wherein the predetermined time interval associated with the venue is based on a number of remote-data-sources located within the venue.

8. The method of claim 6, wherein the predetermined time interval associated with the venue is based on a rate of change of a number of remote-data-sources located within the venue.

9. The method of claim 1, wherein the time-stamped-location-data is generated by an electronic device having at least one sensor.

10. The method of claim 9, wherein the sensor comprises one or more of:
a microphone;
an accelerometer
a chemical sensor;
an orientation sensor;
an optical sensor;
a camera;
a touch screen sensor; and
a thermal sensor.

11. The method of claim 1, further comprising:
defining a preference-set for the particular user; and
searching the database to identify one or more candidate-remote-data-sources based on further matching candidate-time-stamped-location-data with the particular user's preference-set;
wherein the report request relates to the particular user's preference-set.

12. The method of claim 1, further comprising:
receiving a plurality of report-data from each of a plurality of candidate-remote-data-sources;
generating aggregate-report-data from the received plurality of report-data, the aggregate-report-data for use in providing subsequent navigation guidance for the particular user.

13. An apparatus comprising:
at least one processor; and
at least one memory including computer program code,
the at least one memory and the computer program code configured to, with the at least one processor, cause the apparatus to perform at least the following:
define a geographical-area for a particular user;
search a database to identify one or more candidate-remote-data-sources based on matching candidate-time-stamped-location-data with:
the particular user's geographical-area; and
a predetermined discrete time interval;
send a report-request to the one or more candidate-remote-data-sources; and
receive report-data from the one or more candidate-remote-data-sources in response to the report request, the report-data for use in providing subsequent navigation guidance for the particular user,
wherein the database is populated with information relating to a plurality of remote-data-sources, the information comprising time-stamped-location-data for each of the plurality of remote-data-sources.

14. A system comprising the apparatus and the database of claim 13 and a plurality of remote-data-sources configured to provide report-data in response to the report-request.

15. A computer readable medium comprising computer program code stored thereon, the computer readable medium and computer program code being configured to, when run on at least one processor, perform at least the following:
define a geographical-area for a particular user;
search a database to identify one or more candidate-remote-data-sources based on matching candidate-time-stamped-location-data with:
the particular user's geographical-area; and
a predetermined discrete time interval;
send a report-request to the one or more candidate-remote-data-sources; and
receive report-data from the one or more candidate-remote-data-sources in response to the report-request, the report-data for use in providing subsequent navigation guidance for the particular user,
wherein the database is populated with information relating to a plurality of remote-data-sources, the information comprising time-stamped-location-data for each of the plurality of remote-data-sources.

16. The computer readable medium of claim 15, wherein the geographical-area comprises the particular user's location.

17. The computer readable medium of claim 15, wherein the geographical-area comprises a predetermined area surrounding the particular user's location.

18. The computer readable medium of claim 15, wherein the geographical-area comprises a plurality of venues within a boundary and identifying the one or more candidate-remote-data-sources is further based on matching the candidate-time-stamped-location-data with a location of a venue and a predetermined property of the venue.

19. The computer readable medium of claim 15, further comprising:
defining a preference-set for the particular user; and
searching the database to identify one or more candidate-remote-data-sources based on further matching candidate-time-stamped-location-data with the particular user's preference-set;
wherein the report request relates to the particular user's preference-set.

20. The computer readable medium of claim 15, further comprising:
receiving a plurality of report-data from each of a plurality of candidate-remote-data-sources;
generating aggregate-report-data from the received plurality of report-data, the aggregate-report-data for use in providing subsequent navigation guidance for the particular user.
